(19) United States
(12) Patent Application Publication
(10) Pub. No.: US 2013/0285266 A1
(43) Pub. Date: Oct. 31, 2013

(54) APPARATUS FOR RECOVERING PROCESS EXHAUST ENERGY

(71) Applicant: Roger Scott Telvick, Fairfield, OH (US)

(72) Inventor: Roger Scott Telvick, Fairfield, OH (US)

(21) Appl. No.: 13/459,372

(22) Filed: Apr. 30, 2012

(51) Int. Cl. B01F 3/04; F28D 7/00; F28G 9/00

(52) U.S. Cl. 261/155; 165/164; 165/95; 261/152

(57) ABSTRACT

The present disclosure provides for an apparatus for recovering exhaust energy. The apparatus is generally provided with a waste energy stream inlet for directing an incoming waste heat energy stream from a waste energy stream generator, a heat exchanger in fluid communication with the waste energy stream inlet, a waste energy stream outlet distal from the waste energy stream inlet, a recycled energy stream outlet operatively connected and in fluid communication with said air flow that receives heat, and collecting means.

### FIELD OF THE INVENTION

The present disclosure is related to energy conservation and global sustainability by recycling exhaust heat from a manufacturing operation. More particularly, the present disclosure relates to an energy recovery system suitable for use in the recycling and reclaiming of exhaust heat from the drying section of a papermaking machine and process.

### BACKGROUND OF THE INVENTION

Disposable paper products such as facial tissue, sanitary tissue, paper towels, and the like are typically made from one or more webs of paper. Processes for the manufacture of disposable paper products can vary, but generally involve the preparation of aqueous dispersion of papermaking fibers. The aqueous dispersion is deposited on a Fourdrinier wire to form an embryonic web of papermaking fibers on the wire. The Fourdrinier wire and embryonic web can then be transferred to a through air drying belt. The resulting web of cellulosic fibers is then brought into contact with various drying cylinders including a Yankee drying drum, and preferably impressed thereagainst. The tissue is then dried to the desired moisture level on the Yankee drying drum and removed therefrom.

One of the drawbacks of the production of such web materials, especially those web materials suitable for consumer tissue and towel production is that a considerable amount of water is required to produce the embryonic web and considerable heat energy is required to dry the resulting embryonic web to produce the final consumer product. Until now, most of the water and heat energy used in the drying process is wasted by venting to the environment. This heat is generally in the form of steam or moist air generated during the aforementioned drying process. To those familiar with such drying processes, the wasted heat may exceed 80% of the electrical energy used in the process

With an increase in the need for disposable paper products and with the simultaneous increase in the cost and decreased availability of natural and energy resources, there is an increased need to recover and use any wasted heat in order to recover the thermoenergy produced during the paper drying process for use. Clearly, any energy exhausted to the atmosphere lowers the profitability of the process.

When a typical paper drying process is utilized, the quantity of waste heat generated can be as high as 2,000 kWh of energy per one ton of pulp produced and used. It is therefore appreciated that a large amount of thermal energy is wasted during the course of the drying process and such energy leaves in the form of the steam and/or moist air created during the process. As a result, there have been attempts to recover such heat in various types of recovery systems where the atmospheric steam generated during this process is utilized to provide heat in various other situations. For example, such heat recovery systems utilize the steam as a remote heating source for housing developments, for heat ventilation air and/or sanitary water, as well as to preheat combustion and/or drying air of a paper manufacturing machine.

It has been previously suggested that any waste heat and process steam produced during the drying process should be immediately re-injected and used in the drying section in the paper manufacturing machine. Current processes can recycle limited quantities of moist air. However, at a certain level of moisture saturation, energy savings from these recycle systems are lost in reduced drying capability of the hot air stream.

As known in the prior art, a principal object of heat recovery systems is to replace primary energy in an economical way. In some heat recovery systems, heat exchangers, such as plate heat exchangers and tubular heat exchangers can be used. In prior art plate heat exchangers, a plate structure forms two systems of ducts perpendicular to one another. A medium that delivers heat flows in one set of ducts and a medium that receives heat flows in the other set of ducts. The heated receiving medium is then further processed for reuse. Tubular heat exchangers are generally provided with a supply of steam or water, and the tubes are surrounded by ribs or equivalent so as to increase the heat exchange area. In lamellar radiators, the tubes are typically fitted between a plate structure, and water flow in the ducts formed by the plate structure, for example glycol water.

Another form of heat recovery system provides a heat exchanger where an air flow that is moist, saturated, or near its saturation curve is arranged to be used as the air flow that delivers heat. In this system, the air flow that delivers heat is arranged to flow inside vertically oriented tubes substantially from a top of each tube toward a bottom of each tube. The air flow that receives heat is arranged to flow in a direction substantially horizontally through gaps between the tubes. In this manner, any condensate coming from the moist air flow that delivers heat in the tubes flows downward along the inner walls of the tubes and is collected in a basin positioned within the duct work of the heat exchanger below the bottom of the tubes.

However, such a system is severely flawed. Since, the hot, moisture-laden and often particle-laden air goes through the described tubes, the insides of the tubes tends to foul with particle build-up. Clearly, fouling and the production of a condensate layer becomes a significant detriment to efficient heat transfer. This reduces the overall efficiency of the system and can even render the system inoperable. This clearly does not provide any benefit to the user of the system and increases system maintenance.

Thus, it would be advantageous to provide the capability to preheat cold, dry air using warm, moist air while recovering water from the exhaust air stream simultaneously. This can provide significant system energy reduction and significant sustainability benefits in a typical disposable paper product manufacturing process. If such a system were to provide heat exchange rates of 20-40 MMBTU/hr, it may be possible to reduce equivalent amounts of natural gas usage while recovering 40-80 GPM of water per machine. Further, the vacuum created by the condensing water vapor may be expected to deliver 20,000-60,000 CFM of vacuum capacity which may overcome some of the resistance losses caused by the energy recovery process. Besides sustainability efforts, a method for recovering heat and water from moist exhaust air can provide economic benefits as well. Such a system should enable air to air heat recovery of a moist, fiber laden hot exhaust air stream to a clean and dry inlet air stream. Such a system should also minimize fouling and other maintenance-driven issues related to the recovery equipment.

### SUMMARY OF THE INVENTION

The present disclosure provides for an apparatus for recovering exhaust energy. The apparatus is generally provided with a waste energy stream inlet for directing an incoming waste heat energy stream from a waste energy stream generator, a heat exchanger in fluid communication with the waste energy stream inlet, a waste energy stream outlet distal from the waste energy stream inlet, a recycled energy stream outlet operatively connected and in fluid communication with said air flow that receives heat, and collecting means. The waste energy stream comprises air that is moist, saturated, or near its saturation curve. The heat exchanger comprises a duct, a plurality of substantially parallel tubes each having an outer wall arranged in the duct to define gaps therebetween, first means for directing the incoming waste heat energy stream through the duct that delivers heat through the gaps and over the outer walls of the tubes, and second means for directing an air flow that receives heat through the tubes. The waste energy stream outlet is in fluid communication with the heat exchanger and is arranged so that the waste energy stream flows from the waste energy stream inlet to the waste energy stream outlet and condensate forms on the outer wall of the tubes. The collecting means is in contacting engagement with the duct for collecting the condensate flowing along the outer walls of the tubes.

### BRIEF DESCRIPTION OF THE DRAWINGS

FIG. 1 is a block diagram of an exemplary but non-limiting energy recovery process of the present disclosure;

FIG. 2 is a plan view of an exemplary but non-limiting heat exchanger suitable for use with the energy recovery process of the present disclosure;

FIG. 3A is a cross-sectional view of the exemplary but non-limiting heat exchanger of FIG. 2 taken at line 3A, 3B-3A, 3B; and,

FIG. 3B is another cross-sectional view of the exemplary but non-limiting heat exchanger of FIG. 2 taken at line 3A, 3B-3A, 3B showing the spray system in operation.

### DESCRIPTION OF PREFERRED EMBODIMENTS

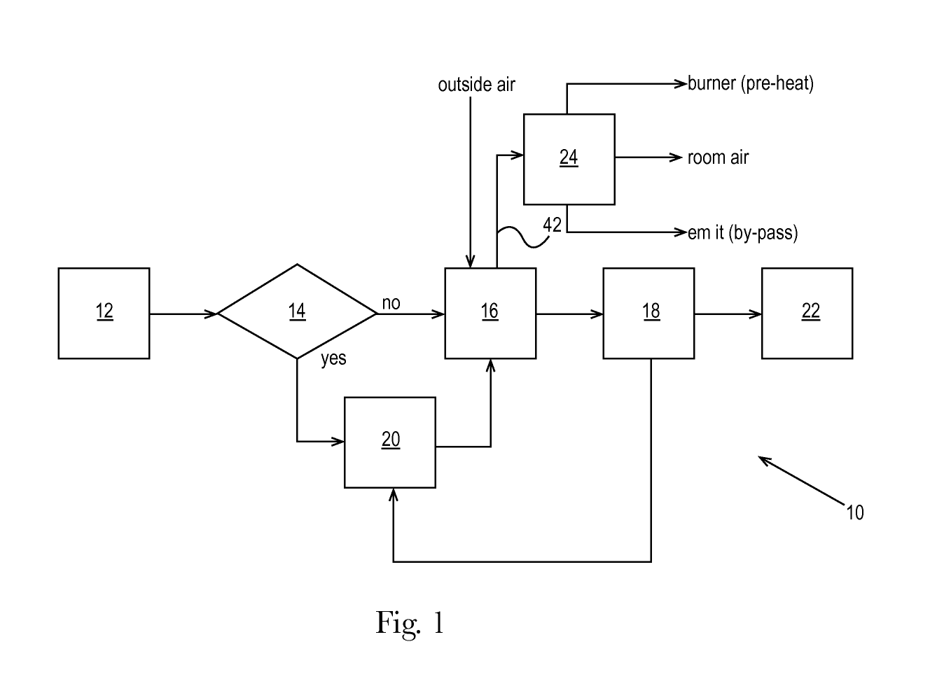

Referring to FIG. 1, the exemplary and non-limiting energy recovery process 10 shown can generally receive a waste heat energy stream 12 in the form of steam, hot air exhaust, moisture laden heated air, particle and/or fiber laden heat exhaust, and the like from a waste heat energy stream generator. One of skill in the art will recognize that any manufacturing process that takes an air stream, supplies heat energy to the stream to accomplish a task and then vents the exhaust is suitable for use with the process and apparatus of the present disclosure and would be considered an exemplary waste heat energy stream generator. Some exemplary manufacturing processes (e.g., waste heat energy stream generators) utilizing such processes are herein described.

For example, by way of non-limiting example, several known pollution control systems utilize afterburners to oxidize volatile organic compound process off-gasses. It is well known that pre-heating this process off-gas stream results in a better and more efficient oxidation process.

Similarly, the radiant heat emitted from a circuit board manufacturing process can be utilized to provide ambient heating to other locations within the manufacturing operation during cool weather seasons.

Further still and by way of non-limiting example, a product such as a continuous web of textile or paper product is generally dried by passing the web substrate over a plurality of sequential heated rotary cylinders. These cylinders are generally heated internally by means of supplied steam or externally by large gas-fired burners. Typically, the hot exhaust gasses and/or waste energy stream resulting from the drying process are usually dissipated in the surrounding atmosphere. Significant energy is required to extract the water residing within the paper product. This is even more evident when it is understood that these web materials are typically manufactured to be about 10 feet wide and are subject to manufacturing speeds of such drying operations typically ranging from 3,000 to 5,000 feet per minute. This requires the webs to be dried very quickly as the final drying stages of typical paper manufacturing operations provide a final product that has about 3% moisture content.

Returning to FIG. 1, the energy recovery process 10 envisions several process steps and non-limiting options suitable for use with the described energy recovery process 10. If the waste heat energy stream 12 is in the form of hot and dry exhaust gas, a step to determine if additional moisture should be added to the waste heat energy stream 12 can be provided. This step is represented in FIG. 1 as 14. In a situation where the waste heat energy is not saturated, and it has been determined that moisture should be added, one selects “yes” on the decision point. Alternatively, if the waste heat energy stream 12 is in the form of steam, then additional saturation may not be required, this can result in the selection of “no” on the decision point. In a preferred embodiment of the energy recovery process 10, one of skill in the art would recognize that it may be preferred that the waste heat energy stream 12 to be treated be saturated. Without desiring to be bound by theory, it would be readily appreciated by one of skill in the art that saturation of the waste heat energy stream 12 can enable and enhance latent heat transfer. Naturally, it should be understood by one of skill in the art that if a decision is made to not saturate waste heat energy stream 12, the herein described equipment and process is still suitable for use. The use or non-use of a saturated waste heat energy stream 12 should not be considered as limiting the scope of the invention disclosed herein. Furthermore, the terms “saturated waste heat energy stream 12” and “waste heat energy stream 12” are used interchangeably herein without effect on the overall disclosure or the equipment described herein.

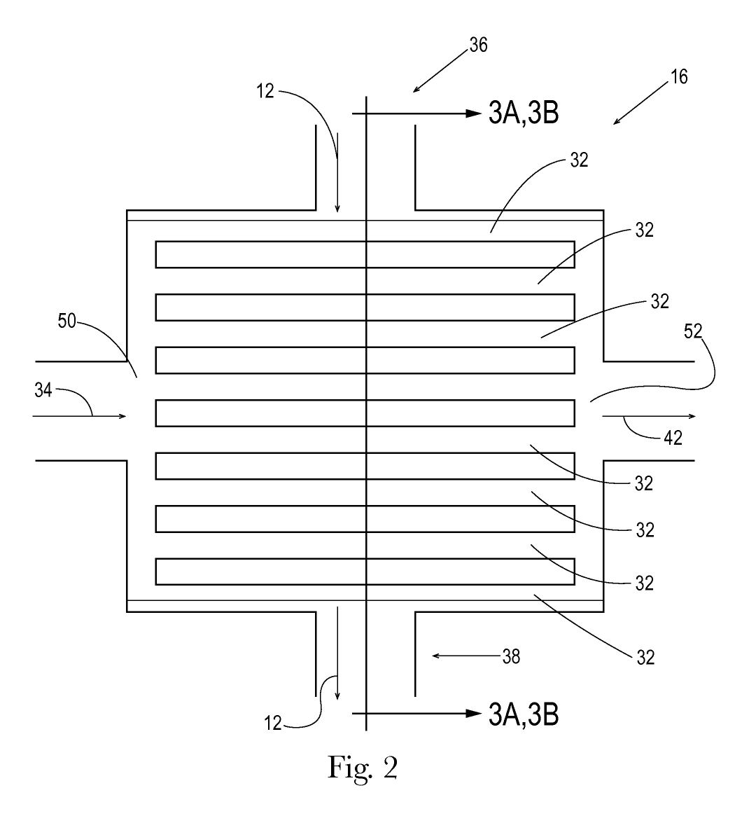

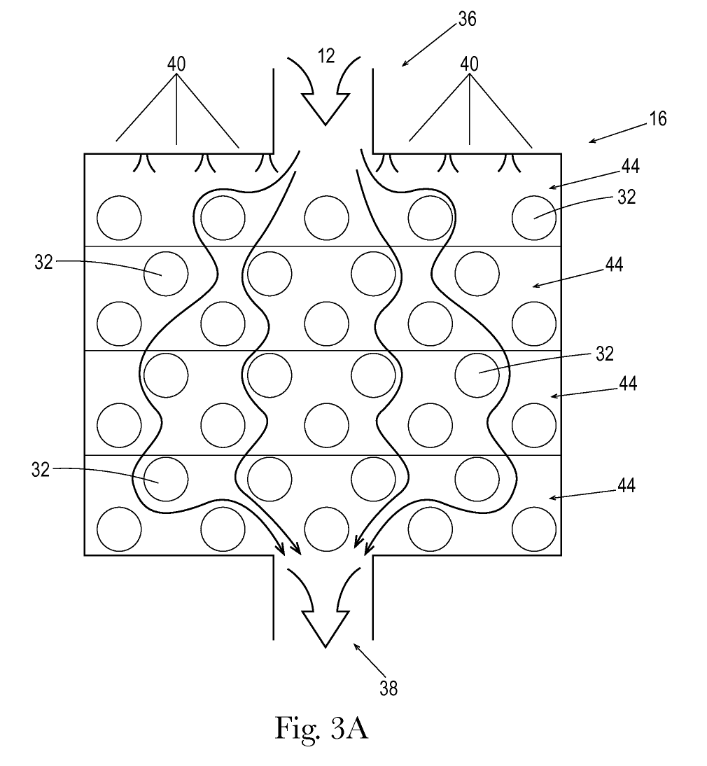

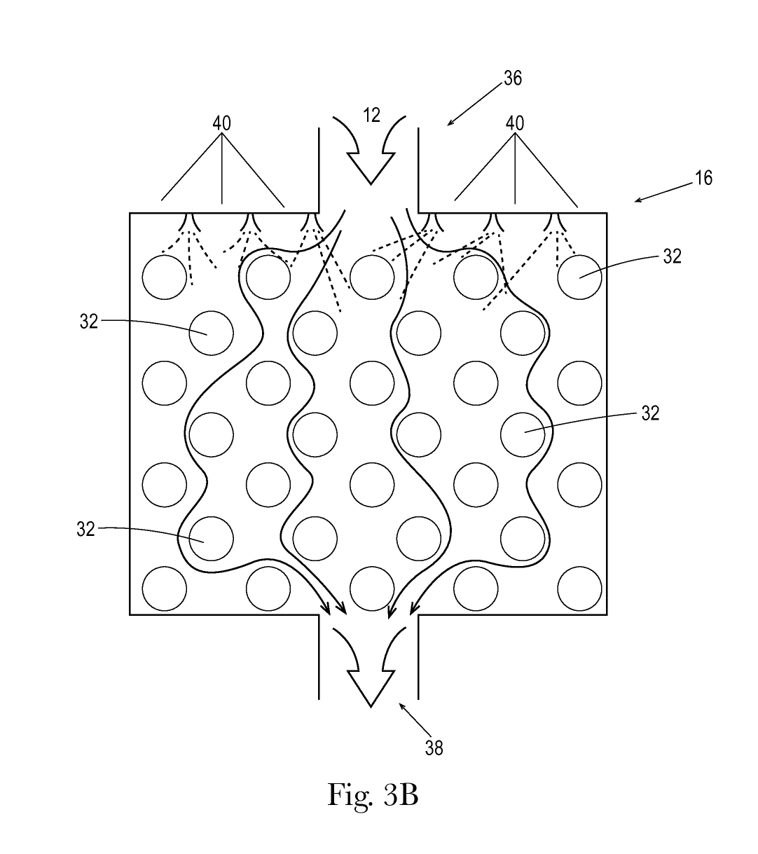

In any regard, the now saturated or unsaturated waste heat energy stream 12 can then be routed to a unique heat exchanger 16. The heat exchanger 16 is shown in detail in FIGS. 2, 3A, and 3B. The saturated waste heat energy stream 12 is passed in accordance with the crossflow principle through the heat exchanger 16. The heat exchanger 16 preferably includes means for directing the saturated waste heat energy stream 12 into and through the heat exchanger 16 (e.g., fans, make-up air, etc) as may be required. The heat exchanger 16 also preferably comprises a number of tubes 32 over which the saturated waste heat energy stream 12 is passed (i.e., external to tubes 32). Fresh air 34 (e.g., clean and uncontaminated) to be heated by the saturated or unsaturated waste heat energy stream 12 can be passed through each of the tubes 32 (i.e., internal to tubes 32). Without desiring to be bound by theory, contact of the saturated waste heat energy stream 12 with the external surface of each of the tubes 32 imparts heat energy to each of the tubes 32. This heat energy is then transferred to the cool fresh air 34 passing through the tubes which can then be recycled in to the manufacturing or other production/use stream.

Additionally, it should be understood that cooling of the saturated waste heat energy stream 12 with the external surface of the tubes 32 caused by a loss of energy upon contact with the tubes 32 can cause any moisture contained within the saturated waste heat energy stream 12 to condense. This condensate can then be collected and also recycled into the manufacturing process or any other production/use stream.

As mentioned supra, heat exchanger 16 preferably consists of a series of tubes 32 containing the fresh air 34 passed therethrough that are to be heated by the saturated waste heat energy stream 12. The saturated waste heat energy stream 12 flows over the tubes 32 that are to be heated to provide the heat required to heat the fresh air 34 contained within tubes 32. In a preferred embodiment, the tubes 32 can be fabricated into a complete unibody construction for heat exchanger 16. In an alternate preferred and non-limiting embodiment, a set of tubes 32 comprising only a portion of the tubes 32 envisioned to provide a complete heat exchanger 16 can be manufactured as an assembly and provided, for example, as a tube bundle 44. It is believed that each tube bundle 44 can be fabricated as incremental, individual units containing a plurality of tubes 32 that are designed to be a portion of the total architecture of the heat exchanger 16. The resulting tube bundles 44 can be arranged and interconnected as may be required by the end user into an array to form a complete heat exchanger 16. For ease of construction, the inlets and outlets of the all the tubes 32 or the respective tube bundles 44, or any portion thereof, comprising heat exchanger 16 can be in common fluid communication through a respective inlet plenum or manifold 50 and/or a respective outlet plenum or manifold 52. In any regard, it is envisioned that the heat exchanger 16 can comprise several design features relating to the disposition of the tubes 32 into any required arrangement articulated infra in order to provide the design required by the user for the waste heat energy stream 12 to be treated.

For example, to be able to transfer heat well, the tube 32 material selected should preferably have good thermal conductivity for the operation and for the waste heat energy stream 12 to be treated. Because heat is transferred from a hot (outer) side to a cold (inner) side through the tubes 32, one of skill in the art will understand that there is a temperature difference through the width of the tubes 32. Because of the tendency of the tube 32 material to thermally expand differently at various temperatures, thermal stresses may occur during operation. This is in addition to any stress imparted to the tubes 32 from the pressures exerted upon the tubes 32 from the fluids (such as waste heat energy stream 12) themselves. The tube 32 material also should be compatible with both the shell and tube 32 side fluids for long periods under the operating conditions (temperatures, pressures, pH, etc.) to minimize deterioration such as corrosion. All of these requirements call for careful selection of strong, thermally-conductive, corrosion-resistant, high quality tube materials, typically metals, including copper alloy, stainless steel, carbon steel, non-ferrous copper alloy, Inconel®, nickel, Hastelloy®, titanium, high conductivity coppers, brasses, wrought Martensitic® stainless steel, aluminum bronzes, 90/10 aluminum bronze, 92/8 aluminum bronze, hard (wrought), 93/7 aluminum bronze, hard (wrought), 95/5 aluminum bronze, ½ hard (wrought), 95/5 aluminum bronze, hard (wrought), nickel iron aluminum bronze, as extruded (wrought), combinations thereof, and the like. Further, tubes 32 can be provided in several non-limiting types including plain, longitudinally finned, radially finned, extruded, rolled, seamed, and the like.

As would be appreciated by one of skill in the art, there are several thermal design features that are to be taken into account when designing the tubes 32 to be placed into shell and tube heat exchangers. It was surprisingly found that using a small tube 32 diameter makes the heat exchanger 16 both economical and compact. However, larger tube 32 diameters can be used. One of skill in the art should consider the tube 32 diameter, the available space, and cost. One of skill in the art would consider the thickness of the wall of the tubes 32 to ensure that any flow-induced vibration has resistance, that there is sufficient axial strength in the structure, that there is sufficient hoop strength (to withstand internal tube pressure), and that there is sufficient buckling strength (to withstand overpressure in the shell).

It should also be understood by one of skill in the art that tube 32 length should be considered in order to make the heat exchanger 16 as long as physically possible whilst not exceeding production capabilities. Additionally, one of skill in the art will appreciate that it is practical to ensure that the tube 32 pitch (i.e., the center-center distance of adjoining tubes 32) is not less than 1.25 times the outside diameter of the tube 32. However, one of skill in the art could use any tube pitch desired to provide the desired air flow and transfer necessary to optimize the performance of heat exchanger 16 for the waste heat energy stream 12 used. Further, it should be understood that the use of corrugated tubes 32 can increase the turbulence of the fluids involved. Without desiring to be bound by theory, it is believed that turbulence can increase heat transfer and provide better performance. However, it should be understood that the arrangement of tubes 32 can be provided in any orientation, spacing, and the like to suit the waste heat energy stream 12 to be treated. Further, one of skill in the art should consider the positioning of tubes 32 within the heat exchanger 16. There are four main types of tube layout, which are, triangular)(30°, rotated triangular)(60°, square)(90° and rotated square)(45°). It was found, and one of skill in the art will no doubt appreciate, that triangular patterns may give greater heat transfer as they force the fluid to flow in a more turbulent fashion around the tubes 32. One of skill in the art will appreciate that square patterns can be employed where high fouling is experienced and cleaning is more regular.

In principle, it is believed that the heat exchanger 16 can be thought of as two fluid streams that are thermally connected (e.g., saturated waste heat energy stream 12 and cool fresh air 34). Let the fluid streams be of equal length, L, with a heat capacity (energy per unit mass per unit change in temperature) and let the mass flow rate of the fluids through the heat exchanger 16 be (mass per unit time), where the subscript i applies to saturated waste heat energy stream 12 and cool fresh air 34.

If one assumes a steady state, so that the temperature profiles are not functions of time, the temperature profiles for the fluid streams (in which each can be thought of as being contained in a pipe) can be represented as T₁(x) and T₂(x) where x is the distance in the tube. Assume also that the only transfer of heat from a small volume of fluid in one tube is to the fluid element in the other tube at the same position. There will be no transfer of heat along a tube due to temperature differences in that tube. By Newton's law of cooling the rate of change in energy of a small volume of fluid is proportional to the difference in temperatures between it and the corresponding element in the other tube. To wit:

$$\frac{d {u}_{1}}{d t} = γ ( {T}_{2} - {T}_{1} )$$

$$\frac{d {u}_{2}}{d t} = γ ( {T}_{1} - {T}_{2} )$$

Here, uᵢ(x) is the thermal energy per unit length and γ is the thermal connection constant per unit length between the two tubes. This change in internal energy results in a change in the temperature of the fluid element. The time rate of change for the fluid element being carried along by the flow is:

$$\frac{d {u}_{1}}{d t} = {J}_{1} \frac{d {T}_{1}}{d x} and , \\ \frac{d {u}_{2}}{d t} = {J}_{2} \frac{d {T}_{2}}{d x}$$

where J₁=Cᵢj is the “thermal mass flow rate”. The differential equations governing the heat exchanger may now be written as:

$${J}_{1} \frac{d {T}_{1}}{d x} = γ ( {T}_{2} - {T}_{1} ) and , \\ {J}_{2} \frac{d {T}_{2}}{d x} = γ ( {T}_{1} - {T}_{2} ) .$$

Note that, since the system is in a steady state, there are no partial derivatives of temperature with respect to time, and since there is no heat transfer along the tube, there are no second derivatives in x as is found in the heat equation. These two coupled first-order differential equations may be solved to yield:

$${T}_{1} = A - \frac{{Bk}_{1}}{k} {e}^{- kx} and , \\ {T}_{2} = A + \frac{{Bk}_{2}}{k} {e}^{- kx}$$

where k₁=γ/J_{1,} k₂=γ/J_{2,} k=k₁+k₂ and A and B are two as yet undetermined constants of integration. Let T₁₀ and T₂₀ be the temperatures at x=0 and let T_{1L} and T_{2L} be the temperatures at the end of the tube at x=L. Define the average temperatures in each tube as:

$${\overline{T}}_{1} = \frac{1}{L} {\int }_{0}^{L} {T}_{1} ( x ) d x and , \\ {\overline{T}}_{2} = \frac{1}{L} {\int }_{0}^{L} {T}_{2} ( x ) d x .$$

Using the solutions above, these temperatures are:

$${T}_{10} = A - \frac{{Bk}_{1}}{k} {T}_{20} = A + \frac{{Bk}_{2}}{k}$$

$${T}_{1 L} = A - \frac{{Bk}_{1}}{k} {e}^{- kL} {T}_{2 L} = A + \frac{{Bk}_{2}}{k} {e}^{- kL}$$

$${\overline{T}}_{1} = A - \frac{{Bk}_{1}}{{k}^{2} L} ( 1 - {e}^{- kL} ) {\overline{T}}_{2} = A + \frac{{Bk}_{2}}{{k}^{2} L} ( 1 - {e}^{- kL} ) .$$

Choosing any two of the above temperatures will allow the constants of integration to be eliminated, and that will allow the other four temperatures to be found. The total energy transferred is found by integrating the expressions for the time rate of change of internal energy per unit length:

$$\frac{d {U}_{1}}{d t} = {\int }_{0}^{L} \frac{d {u}_{1}}{d t} d x = {J}_{1} ( {T}_{1 L} - {T}_{10} ) = γ L ( {\overline{T}}_{2} - {\overline{T}}_{1} ) and , \\ \frac{d {U}_{2}}{d t} = {\int }_{0}^{L} \frac{d {u}_{2}}{d t} d x = {J}_{2} ( {T}_{2 L} - {T}_{20} ) = γ L ( {\overline{T}}_{1} - {\overline{T}}_{2} ) .$$

By the conservation of energy, the sum of the two energies is zero. The quantity T₂−T₁ is known as the “log mean temperature difference” and is a measure of the effectiveness of the heat exchanger in transferring heat energy. Without desiring to be bound by theory, it is believed that the heat exchanger of the present invention can be made profitable with as low as 40% thermal efficiency, provided the costs of construction are reasonable. Thus, it should be understood that the heat exchanger of the present invention would provide an efficiency of greater than 50%, or greater than 60%, or greater than 80%, or greater than 90%. However, it should be appreciated that even lower thermal efficiency payouts may be possible with longer project life analysis or even lower cost construction methods.

In practice, saturated waste heat energy stream 12 is passed through gaps defined between the tubes 32. Preferably, the saturated waste heat energy stream 12 passes through the heat exchanger 16 in a direction that is generally orthogonal to the longitudinal axis of tubes 32 and the air flow occurring therein, cross flow to the cold, dry air stream.

Any water condensed in the heat exchanger 16 from waste heat energy stream 12 flows into a basin 18. From the basin 18, any condensed water removed from the saturated waste heat energy stream 12 can be recirculated. By way of non-limiting example, this recirculation can be directed toward a spraying system 20 used for providing water to enable saturation of an unsaturated waste heat energy stream 12 prior to entry of the waste heat energy stream 12 into the heat exchanger 16. Additionally, any condensed water removed from the saturated waste heat energy stream 12 can be used for re-introduction into various portions of the papermaking process and systems communicatingly associated thereto 22. By way of non-liming example, clean water can be provided for input into the initial stages of the papermaking process, such as the pulper as well as other systems associated with the preparation of pulp for the production of paper products. Similarly, clean recycled water can be provided for input into a steam generation system used to generate the steam necessary for the various drying stages of the papermaking process. Additionally, if the condensed water stream is heated, this heated water can be filtered and input into a potable or unpotable water supply stream.

Even still the clean recycled water can be provided for input into the heat exchanger 16 to provide a cleaning benefit to the external surfaces of the tubes 32 disposed within the heat exchanger 16 used in the heat exchanging process described herein. Such a cleaning benefit can be realized by the incorporation of spray system 40. An exemplary spray system 40 can incorporate a pump or an equivalent actuator for passing the flow of water into the nozzles of spray system 40. Spray system 40 was surprisingly found to provide excellent cleaning abilities inasmuch as any particulate matter residing within the saturated waste heat energy stream 12 will tend to bind upon the outer surface of tubes 32 comprising heat exchanger 32. It should be realized by one of skill in the art that the efficiency of heat exchanger 16 is dependent upon the most efficient transfer of thermal energy from the saturated waste heat energy stream 12 disposed upon the outside of tubes 32 to the fresh air 34 disposed within tubes 32. The deposition of particulate matter or any other contaminant upon the outer surface of tube 32 can impact the heat transfer and ultimately the efficiency of the heat exchanger 32. Providing a spray system 40 that effectively washes particulate matter from the outer surface of tube 32 can be reasonably assumed to assist in maintaining optimal heat transfer and optimal efficiency of heat exchanger 16.

Further, it was surprisingly found that by providing the saturated waste heat energy stream 12 in contact with the outer surface of tube 32 eliminates the significant draw-backs associated with the systems found in the prior art. For example, any particulate matter residing in the saturated waste heat energy stream 12 does not have the opportunity to become impacted upon the inner surface of tube 32 resulting in a difficult, if not nearly impossible, cleaning task. Such a system would likely require a complete disassembly of the system in order to effect any cleaning process. Any particulate deposition upon the outer surface of tubes 32 is more readily removable than impacted particulate matter disposed within a tube 32.

The cooled flow of exhaust air from waste heat energy stream 12 may still contain moisture droplets even after waste heat energy stream 12 has passed through the heat exchanger 16. Thus, the remaining waste heat energy stream 12 can be passed through a drop trap disposed in a supplied exhaust duct. As shown in FIG. 2, the saturated waste heat energy stream 12 is preferably introduced into the top portion of the heat exchanger 16. After this, the saturated waste heat energy stream 12 passes through the heat exchanger 16 and any condensate falls mostly onto the bottom of the heat exchanger 16. This condensate can be removed through an exhaust duct, or it can be recirculated to be used again in spraying system 20 for further saturation of the incoming waste heat energy stream 12 or it can be used in spray system 40 for cleaning the outer surfaces of the tubes 32 of heat exchanger 16, and the like. In either case, any condensate retrieved by heat exchanger 16 would likely be passed into appropriate ducting in which there is a pump or an equivalent actuator for passing the flow of water into the spray system 20 or spray system 40. Since a large quantity of water is employed in the arrangement of the present invention in the heat exchanger 16, it is easy to keep the heat exchanger 16 clean, in which case it does not require a large amount of cleaning, which also provides the advantage that the exhaust side of heat exchanger 16 is not readily blocked.

The heat exchanger in accordance with the present disclosure is suitable for use as a heat exchanger to provide clean and heated exhaust air 42. For example, clean and heated exhaust air 42 can be used to provide pre-heated replacement air for a paper machine or for any other application of recovery of heat. A route for the recovered clean and heated exhaust air 42 can be selected by diverter 24. For example clean and heated exhaust air 42 can be routed by diverter 24 to provide pre-heated replacement air for a paper machine as discussed supra. Alternatively, clean and heated exhaust air 42 can be used for climate control within the manufacturing facility or other related operations in the form of heated room air. In the event of a malfunction, maintenance, any exigent circumstance, and the like, clean and heated exhaust air 42 can alternatively be vented to the atmosphere.

It is believed that the heat exchanger 16 in accordance with the invention can be used highly advantageously in process outlets at paper, pulp and board machines, in particular in the process outlets of a dryer section of such machines. In any event, when the present invention is applied to paper mills utilizing several paper machines, a favorable situation can be obtained whereby substantial thermal recovery is achieved. The present invention provides both a technically and economically feasible solution for recovering and re-utilizing large quantities of heat and other energy generated during paper production in order to dry paper. It is based upon the idea that the pressure of the steam need only be raised as is required. As a result, the arrangement can be made even more practical by connecting it together with an additional steam generating system, such as the back pressure power station described.

Various other variations and modifications from the embodiments described can also be included. For example, the heat exchanger 16, diverter 24, and basin 18 may be constructed as an integral unit or as separate units, as described. Also, several parallel vaporizers can be utilized to produce steam at different pressures. Each of them may then be fed into a surface steam feeding group of the papermaking machine dryer section without the need for raising the pressure and preferably without lowering the pressure. For example, such a system can be used to increase dry hot air temperature for use in through air drying.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An apparatus for recovering exhaust energy, the apparatus comprising:
a waste energy stream inlet for directing an incoming waste heat energy stream from a waste energy stream generator, said waste energy stream comprising air that is moist, saturated, or near its saturation curve;
a heat exchanger in fluid communication with said waste energy stream inlet, said heat exchanger comprising a duct, a plurality of substantially parallel tubes each having an outer wall arranged in said duct to define gaps therebetween, first means for directing said incoming waste heat energy stream through said duct that delivers heat through the gaps and over said outer walls of said tubes, and second means for directing an air flow that receives heat through said tubes;
a waste energy stream outlet distal from said waste energy stream inlet, said waste energy stream outlet being in fluid communication with said heat exchanger and being arranged so that said waste energy stream flows from said waste energy stream inlet to said waste energy stream outlet and condensate forms on said outer wall of said tubes;
a recycled energy stream outlet operatively connected and in fluid communication with said air flow that receives heat; and,
collecting means in contacting engagement with said duct for collecting said condensate flowing along said outer walls of said tubes.

2. The apparatus of claim 1 further comprising spray means for optionally spraying an aqueous medium in an atomized phase into said incoming waste heat energy stream.

3. The apparatus of claim 1 wherein said tubes further comprise members projecting into the gaps to increase the external surface area of said tubes over which said incoming waste heat energy stream passes.

4. The apparatus of claim 1 wherein said substantially parallel tubes are provided in a tube bundle assembly.

5. The apparatus of claim 4 wherein a plurality of tube bundle assemblies are assembleable into an array within said duct to define said gaps.

6. The apparatus of claim 1 wherein each tube of said substantially parallel tubes has an inlet in fluid communication with an inlet of at least another substantially parallel tube.

7. The apparatus of claim 6 wherein each inlet of said substantially parallel tubes are in fluid communication through a plenum.

8. The apparatus of claim 1 wherein each tube of said substantially parallel tubes has an outlet in fluid communication with an outlet of at least another substantially parallel tube.

9. The apparatus of claim 8 wherein each outlet of said substantially parallel tubes are in fluid communication through a plenum.

10. The apparatus of claim 1 wherein each of said substantially parallel tubes are corrugated.

11. The apparatus of claim 1 further comprising a spray system, said spray system being adapted to clean said outer walls of said substantially parallel tubes.

12. The apparatus of claim 1 further comprising a spray system, said spray system being adapted to saturate said incoming waste heat energy stream before said incoming waste heat energy stream contacts said outer wall of said tubes.

13. The apparatus of claim 1 wherein said air flow that receives heat through said tubes is directable toward a manufacturing process that produced said incoming waste heat energy stream.

14. The apparatus of claim 1 wherein said air flow that receives heat through said tubes is recycled by being directed toward a manufacturing process that produced said incoming waste heat energy stream.

15. The apparatus of claim 14 wherein said air flow that receives heat is directed toward a drying section of a papermaking process.

16. The apparatus of claim 1 wherein said air flow that receives heat is directed to provide recycled heated room air.

17. The apparatus of claim 1 wherein said condensate is recycled by being directed toward a manufacturing process that produced said incoming waste heat energy stream.

18. The apparatus of claim 17 wherein said condensate is re-cycled by being directed toward a papermaking process.

19. The apparatus of claim 1 wherein said tubes are manufactured from a metal selected from the group consisting of copper alloy, stainless steel, carbon steel, non-ferrous copper alloy, Inconel, nickel, Hastelloy,titanium, high conductivity coppers, brasses, wrought Martensitic stainless steel, aluminium bronzes, 90/10 aluminium bronze, cold wkd (wrought), 92/8 aluminium bronze, hard (wrought), 93/7 aluminium bronze, hard (wrought), 95/5 aluminium bronze, ½ hard (wrought), 95/5 aluminium bronze, hard (wrought), nickel iron aluminium bronze, as extruded (wrought), combinations thereof, and the like.

20. The apparatus of claim 1 wherein said heat exchanger has a log mean temperature difference of at least about 40 percent.
